(19) United States
(12) Patent Application Publication
(10) Pub. No.: US 2022/0387233 A1
(43) Pub. Date: Dec. 8, 2022

(54) TORQUE TRANSMISSION ASSEMBLY, AND SYSTEMS AND METHODS OF USING SAME

(71) Applicant: UNITED STATES GOVERNMENT AS REPRESENTED BY THE DEPARTMENT OF VETERANS AFFAIR, Washington, DC (US)

(72) Inventor: Steven M. Morin, Minneapolis, MN (US)

(21) Appl. No.: 17/770,235

(22) PCT Filed: Oct. 21, 2020
(86) PCT No.: PCT/US2020/056576

§ 371 Date: Apr. 19, 2022

Related U.S. Application Data
(60) Provisional application No. 62/923,940, filed on Oct. 21, 2019.

(51) Int. Cl. A61G 5/02

(52) U.S. Cl. CPC A61G 5/023; A61G 5/026

(57) ABSTRACT

A drive assembly can comprise a plurality of drive arms that are configured to receive a tangential drive force and convert the tangential drive force to a torque about a first axis. A driven rotatable element can be rotatable about a second axis that is parallel to the first axis. A coupling subassembly can couple the plurality of drive arms to the driven rotatable element so that the first axis is movable with respect to the second axis in first and second dimensions that are perpendicular to each other and the first and second axes. The coupling subassembly can be configured to bias the driven rotatable element toward a position in which the first axis is collinear with the second axis.

### FIELD

This disclosure relates to variable torque transmission assemblies, systems, and methods.

### BACKGROUND

The most common form of a manual wheelchair utilizes a push rim connected directly to drive wheels. The wheelchair user is able to propel the wheelchair by pushing the push rims with her hands, thereby rotating the wheel an equal angle to the angular rotation of the push rims and translating the chair forward. The common wheelchair is elegant in its simplicity. However, the inherent mechanical coupling of the push rim and the wheel require that they be placed in the same fore-aft position (i.e., centered about a common axis), which can lead to reduced stability of the wheelchair and/or shoulder problems. In setup of the common wheelchair, the clinician must balance concerns of shoulder biomechanics and stability of the wheelchair. On one hand, the clinician would like to move the push rims forward to promote a better positioning of the shoulders for propulsion. On the other hand, the axel of the wheels must remain behind the center of gravity to reduce the likelihood the wheelchair will tip over backward. A common approach is to move the push rim/wheel combination as far forward as possible while still maintaining a stable base of support of the wheelchair by positioning the drive wheel and front casters to frame the center of gravity in fore/aft directions. In addition to the difficulty in positioning the push rim/wheel combination, the fixed coupling of the wheel and push rim does not provide any variable mechanical advantage between the push rims and the wheels.

Wheelchairs can have push rims that are coupled to the drive wheels by a belt or chain. These systems typically have fixed gearing and do not have a transmission, so the wheelchairs rely on high input torque to traverse steep hills and obstacles.

### SUMMARY

Disclosed herein, in one aspect, is a drive assembly comprising a plurality of drive arms that are configured to receive a tangential drive force and convert the tangential drive force to a torque about a first axis. A driven rotatable element can be rotatable about a second axis that is parallel to the first axis. A coupling subassembly can couple the plurality of drive arms to the driven rotatable element so that the first axis is movable with respect to the second axis along both (i) a first dimension that is perpendicular to the first and second axes and (ii) a second dimension that is perpendicular to the first dimension and the first and second axes. The coupling subassembly can be configured to bias the driven rotatable element toward a position in which the first axis is collinear with the second axis.

In another aspect, a wheelchair can comprise a frame and a pair of drive wheels that are rotatably coupled to the frame about a drive wheel axis. A drive assembly can be coupled to each drive wheel. The drive assembly can comprise a plurality of drive arms that are rotatably coupled to the frame about a first axis. A push rim can be coupled to the plurality of drive arms. A first sprocket can be coupled to the plurality of drive arms via a coupling subassembly. The coupling subassembly can couple the plurality of drive arms to the first sprocket so that the first axis is movable with respect to the second axis along both (i) a first dimension that is perpendicular to the first and second axes and (ii) a second dimension that is perpendicular to the first dimension and the first and second axes. The coupling subassembly can be configured to bias the first sprocket toward a position in which the first axis is collinear with the second axis. A second sprocket can be is fixedly coupled to a respective drive wheel of the pair of drive wheels. A spacing arm can be coupled to each of the first sprocket and the second sprocket to maintain the first and second sprockets at a select spacing. A belt or chain can extend between and engaging each of the first sprocket and the second sprocket.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE FIGURES

These and other features of the preferred embodiments of the invention will become more apparent in the detailed description in which reference is made to the appended drawings wherein:

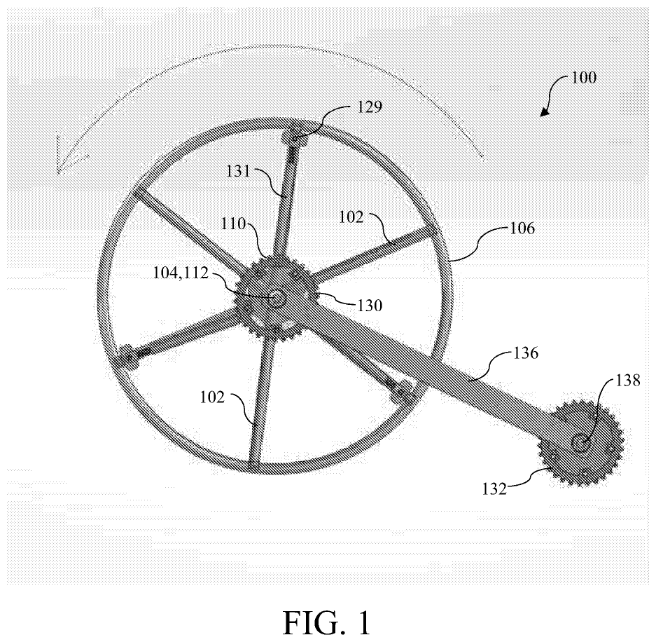

FIG. 1 is a side view of a drive assembly in accordance with embodiments disclosed herein when the input torque is low or zero.

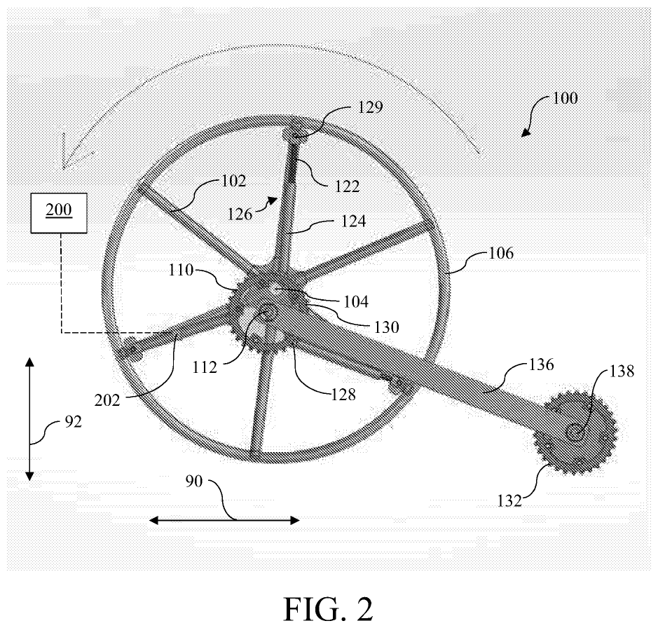

FIG. 2 is a side view of the drive assembly of FIG. 1 with a significant input torque applied.

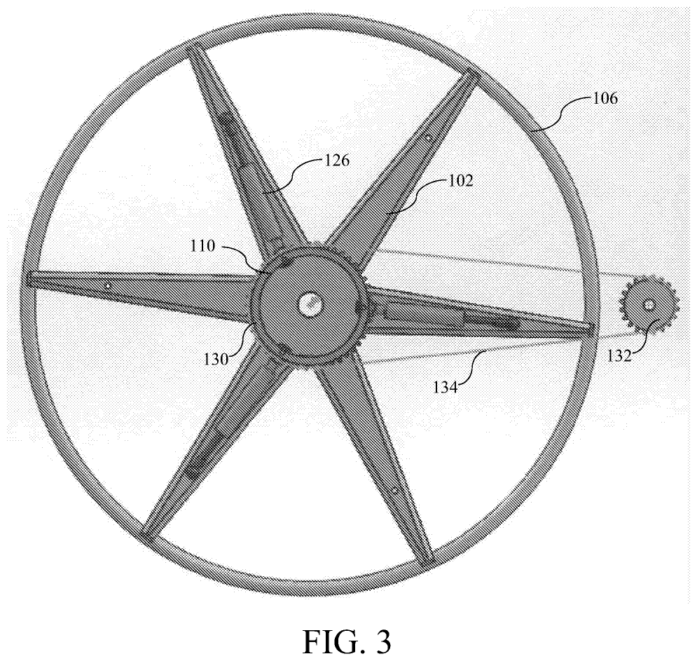

FIG. 3 is a side view of another drive assembly in accordance with embodiments disclosed herein when the input torque is low or zero.

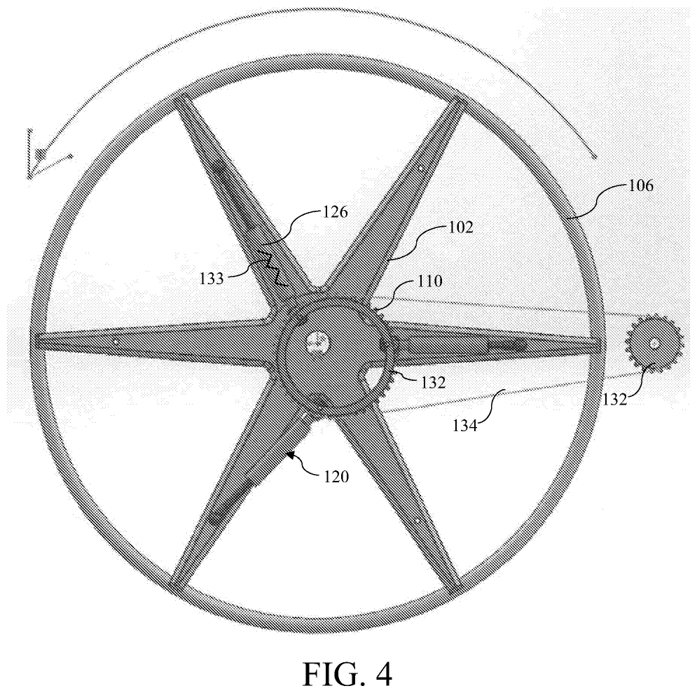

FIG. 4 is a side view of the drive assembly of FIG. 3 with a significant input torque applied.

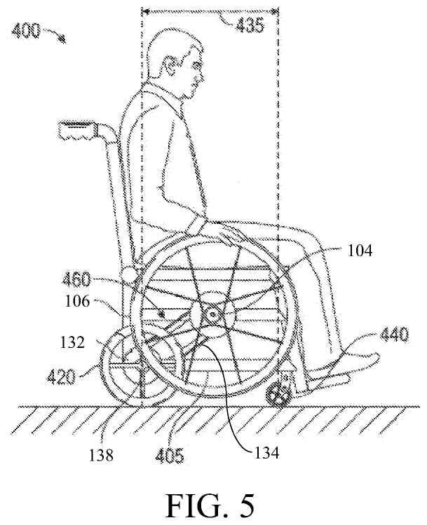

FIG. 5 is a side view of an exemplary wheelchair comprising the drive assembly as disclosed herein.

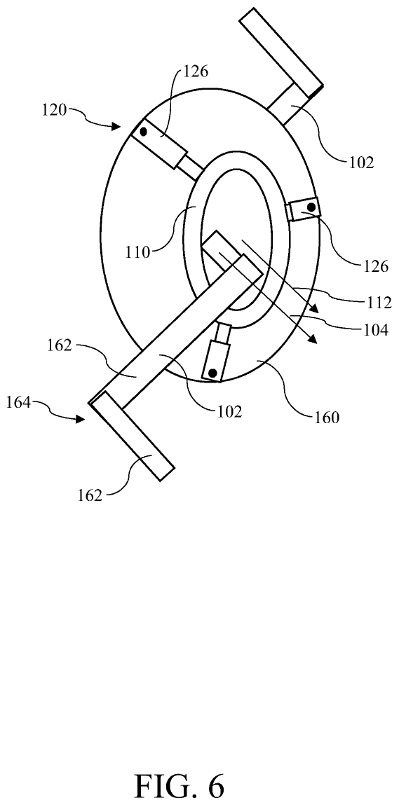

FIG. 6 is a schematic diagram of a bicycle pedal crank assembly comprising a drive assembly in accordance with embodiments disclosed herein.

### DETAILED DESCRIPTION

The present invention can be understood more readily by reference to the following detailed description, examples, drawings, and claims, and their previous and following descriptions. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a wheel” can include two or more such wheels unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially collinear”) or “generally” (e.g., “generally collinear”) should be understood to include embodiments in which angles are within about ten degrees, or within five degrees, or within one degree.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

Described herein with reference to FIGS. 1-4 is a drive assembly 100. In various aspects, the drive assembly 100 can comprise a plurality of drive arms 102 that are configured to receive a tangential drive force and convert the tangential drive force to a torque about a first axis 104. As should be understood, for a body that is rotatable about an axis, a force that is tangential to the axis and is applied at a location that is radially spaced from the axis can cause a torque about the axis. Optionally, for example, the drive arms 102 can be spokes that couple to a push rim 106.

The drive assembly 100 can be configured to apply a torque to a driven rotatable element 110. The driven rotatable element 110 can be rotatable about a second axis 112 that is parallel (or substantially parallel) to the first axis 104. In various aspects, the driven rotatable element 110 can be a sprocket. The driven rotatable element 110 can be coupled to the plurality of drive arms so that the second axis 112 is movable with respect to (i.e., toward or away from) the first axis 104 in a first dimension 90 that is perpendicular to the first and second axes 104, 112 and in a second dimension 92 that is perpendicular to the first and second axes 104, 112 and the first dimension 90.

The drive assembly 100 can comprise a coupling subassembly 120 that couples the drive arms 102 to the driven rotatable element 110 so that the second axis 112 is movable with respect to (i.e., toward or away from) the first axis 104 in the first and second dimensions 90, 92. The coupling subassembly 120 can bias the second axis 112 to be collinear or substantially collinear with the first axis 104. The coupling subassembly 120 can comprise a plurality of spring-biased pushrods 122 (e.g., piston rods that are movable along a cylinder). In optional aspects, the coupling subassembly 120 can comprise a plurality of (e.g., three) pushrods that are equally circumferentially spaced about the driven rotatable element 110 in a satellite arrangement.

Each of the spring-biased pushrods 122 can be slidable within a respective housing 124 (e.g., a cylinder). The pushrod 122 can be biased outwardly from the respective housing 124 via a spring. Said spring can optionally be, for example, a gas spring 131 (FIG. 1) or a coiled spring 133 (shown schematically in FIG. 4), or a combination thereof The spring can optionally comprise a progressive-rate spring. In various aspects, a damper 126 can comprise a spring-biased pushrod, housing, and spring(s) associated therewith.

The dampers 126 can be coupled to and extend between the driven rotatable element 110 and the drive arms 102 at respective pivotal couplings at each end. For example, in various optional aspects, each housing 124 can be coupled to the driven rotatable element 110 at a pivotal coupling 128, and the pushrods can be coupled to respective drive arms 102 at pivotal couplings 129. In further optional aspects, each housing 124 can be coupled to respective drive arms 102, and the pushrods can be coupled to the driven rotatable element 110. In still further aspects, the pushrods 122 or the housings 124 can be directly coupled to the push rim, thereby forming an indirect coupling to the drive arms 102. The pivotal couplings 128, 129 can optionally each comprise a ball joint rod end.

The pushrods 122 can be pivotably coupled to the driven rotatable element 110. Optionally, the radial movement about the respective pivotal connections of the pushrods 122 can be limited to prevent torque wrapping of the springs out of their operating range. Optionally, this limited radial movement can be limited by limiting linear travel between the pushrods 122 and their respective housings 124.

In some aspects, the driven rotatable element 110 can be a first sprocket 130. The first sprocket 130 can be coupled to a second sprocket 132 via a belt or chain 134 (FIG. 3). The second sprocket 132 can be rotatable about a third axis 138 that is parallel to and offset from the first axis 104. The second sprocket can be fixedly coupled to a drive wheel of a wheelchair so that rotation of the second sprocket causes corresponding rotation of the drive wheel. The first sprocket 130 can be coupled to the second sprocket 132 via a spacing arm 136 that is configured to maintain the first and second sprockets at a select linear spacing. In this way, the second sprocket can be configured to move angularly about the third axis 138 without changing the amount of tension on the belt or chain 134.

In use, it is contemplated that the drive assembly 100 can passively change the mechanical advantage between the input force and the driven rotational element. For example, as shown in FIG. 1, under low or no torque, the coupling subassembly 120 can maintain the driven rotatable element 100 (e.g., the first sprocket 130) centered relative to the drive arms 102 so that the first and second axes 104, 112 are collinear. Under low drive forces, the coupling subassembly 120 can dampen movement of the driven rotatable element 110 to resist movement of the second axis with respect to (i.e., toward or away from) the first axis. This damping can further resist movement on extreme initial forces, thereby inhibiting, for example, a powerful user from causing a wheelchair to do a wheelie (i.e., pivot so that the wheelchair rides on only the two drive wheels. The drive assembly 100 can further smooth out the ride of the user for a more comfortable experience.

Under greater input (drive) forces, corresponding to higher torque, such as, for example, on a slope or with the drive wheel encountering an obstacle, the input force can cause the coupling subassembly 120 to allow the driven rotatable element 110 to move away from the input force. This movement of the driven rotatable element 110 can cause the moment arm about the second axis to increase, thereby providing a mechanical advantage to overcome a slope or an obstacle. For example, the spring-biased pushrods can compress the springs within their respective housings. Upon the drive force decreasing, the coupling subassembly 120 can return the driven rotatable element 110 back to a coaxial position with the drive arms 102. In this way, the disclosed torque conversion assembly can provide a continuously variable transmission.

It is contemplated that the spring forces of the spring-biased pushrods 122 can be tailored for a given user, activity, or terrain condition. For example, the springs within the housings can be replaced with stiffer or less stiff springs. In further optional aspects, one or more of the dampers 126 can be replaced with a damper having different damping or rebound characteristics. In further aspects, the coupling subassembly 120 can comprise adjustable progressive dampers, powered electric, pneumatic, or hydraulic actuators to control damping and rebound characteristics.

Optionally, a kit can comprise a plurality of springs that are receivable into the housing 124, wherein the springs have different characteristics. For example, the springs can have different operative lengths and/or different spring rates (optionally, linear spring rates or non-linear spring rates). In this way, the drive assembly 100 can be customized for different users, different activities, or different terrain. Optionally, the kit can further comprise the housing 124 and the pushrod 122.

In further aspects, at least one damper can be configured to have a selectively variable characteristic (or a plurality of selectively variable characteristics). The characteristic of the at least one damper can optionally comprise at least one of a damping force, a linear travel, or a rebound rate of at least one damper 126. For example, a damper can by hydraulically or pneumatically actuated, and one or more valves through which hydraulic fluid or air passes can be adjusted to alter the damping rate of the damper.

Optionally, a user can manually select a characteristic of at least one damper. For example, a controller 200 can receive a user input (e.g., via a push button, touch screen, keyboard, or any other suitable input device) and vary the characteristic of at least one damper 126 based on the user input. For example, a user can selectively lock the movement of the driven rotatable element 110 relative to the drive arms 102 or change the stiffness of the damper(s) 126 to allow more or less linear travel for a given applied torque.

In various aspects, the controller 200 can be in communication with at least one sensor 202. The at least one sensor can optionally comprise at least one of a force sensor, a torque sensor, or a displacement sensor. The controller 200 can be programmed to receive an input from the at least one sensor and adjust a characteristic of at least one damper 126.

Optionally, one damper can be actively controlled by the controller, and the other dampers can be controlled as a function of the active control of the one damper.

Optionally, the coupling subassembly 120 can be configured to be locked to inhibit movement of the driven rotatable element 110 with respect to the drive arms 104. Optionally, this can be done via locking of the dampers. In further aspects, the spacing arm 136 can optionally be configured to selectively lock to inhibit movement of the driven rotatable element 110. In this way, the torque can remain constant. This can be desirable, for example to prevent the mechanical advantage of the device from working against a user when in coasting or braking. This could be done by limiting the links travel radially to prevent moving the sprocket 130. In further aspects, the spacing arm 136 can be locked in position, actuated, or dampened, to “hold” a given mechanical advantage.

### Exemplary Wheelchair

FIG. 5 depicts an example wheelchair with a push rim that is coupled via a belt or chain to a drive wheel. The wheelchair 400 can comprise a frame 405, a rotatable push rim 410 connected to the frame 405, and a drive wheel 420 connected to the frame 405. The wheelchair 400 may also include caster wheels 440 located in front of the drive wheel 420. The caster wheels 440 and the drive wheels 420 collectively form the base of support 435 of the wheelchair. In order to provide a stable ride for the user, it may be preferable that caster wheels 440 and the drive wheels be positioned such that the user's center of gravity is located directly above (or substantially directly above) the base of support 435, rather than in front of or behind the base of support 435.

The axis of rotation 425 of the drive wheel 420 can be offset from the axis of rotation 415 of the push rim 106. Thus, instead of being directly coupled to each other, the push rim 410 and drive wheel 420 can be connected by a transmission 460. The transmission 460 can comprise the first sprocket that is coupled to the push rim 106, the second sprocket that is fixedly coupled to the drive wheel 420, and the belt or chain 134. Further exemplary aspects of the wheelchair in accordance with embodiments disclosed herein are provided in U.S. Pat. No. 10,588,795, granted Mar. 17, 2020, the entirety of which is hereby incorporated by reference herein.

### Other Embodiments

In various aspects, the torque conversion assembly 100 as disclosed herein can be incorporated into various drive systems, including, for example and without limitation, a bicycle or power equipment (e.g., belt or chain-driven power equipment).

Referring to FIG. 6, in various aspects, to provide a drive system of a bicycle, a backing plate 160 (e.g., optionally, a flat, circular disc) can be fixedly coupled to a pedal crank 162 so that rotation of the pedal crank causes corresponding rotation of the backing plate. Pedals 166 can be coupled to distal ends 164 of crank arms (drive arms 102) of the pedal cranks 162 for providing the input force/torque to the pedal crank. The sprocket 130 of the bicycle (that is conventionally fixedly coupled to the pedal crank) can couple to the backing plate 160 via the coupling subassembly 120 as described herein so that the rotational axis 112 of the sprocket 130 can be movable with respect to the rotational axis 104 of the backing plate 160. Accordingly, it is contemplated that the coupling 120 between the drive arms 102 and the sprocket 130 can comprise a coupling between the pedal crank 162 and the backing plate 160; a coupling between the backing plate and each damper 126; and couplings between the sprocket 130 and the dampers 126.

It is contemplated that the drive arms 102, disclosed herein, can be embodied as any moment arm that is rotatable about a given axis. Accordingly, the drive arms can be embodied as couplings that are spaced from the given axis rotational axis of a body. For example, a disc having a rotational axis can define drive arms as couplings that receive input forces at locations spaced from the rotational axis of the disc. Accordingly, the drive arms 102 are not limited to elongate members. For example, the drive arms can comprise a pedal crank, an input pulley, an input sprocket, or any other structure that is capable of providing a 4rotational force.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A drive assembly comprising: a plurality of drive arms that are configured to receive a tangential drive force and convert the tangential drive force to a torque about a first axis; a driven rotatable element that is rotatable about a second axis that is parallel to the first axis; a coupling subassembly that couples the plurality of drive arms to the driven rotatable element so that the first axis is movable with respect to the second axis along both (i) a first dimension that is perpendicular to the first and second axes and (ii) a second dimension that is perpendicular to the first dimension and the first and second axes, wherein the coupling subassembly is configured to bias the driven rotatable element toward a position in which the first axis is collinear with the second axis.

Aspect 2: The drive assembly of aspect 1, further comprising a push rim that is coupled the plurality of drive arms.

Aspect 3: The drive assembly of aspect 1 or aspect 2, wherein each drive arm comprises a proximal end intersected by the first axis and a distal end opposing the proximal end, the torque conversion assembly further comprising a pedal coupled to the distal end of each drive arm of the plurality of drive arms.

Aspect 4: The drive assembly of any one of the preceding aspects, wherein the driven rotatable element is a first sprocket, the torque conversion assembly further comprising: a second sprocket; a spacing arm that is coupled to each of the first sprocket and the second sprocket to maintain the first and second sprockets at a select spacing; and a belt or chain extending between and engaging each of the first sprocket and the second sprocket.

Aspect 5: The drive assembly of any one of the preceding aspects, wherein the coupling subassembly comprises a plurality of spring-biased pushrods that are coupled between the plurality of drive arms and the driven rotatable element.

Aspect 6: The drive assembly of aspect 5, wherein the spring-biased pushrods comprise coiled springs.

Aspect 7: The drive assembly of aspect 5, wherein the spring-biased pushrods comprise air springs.

Aspect 8: The drive assembly of any one of aspects 5-7, wherein the plurality of spring-biased pushrods comprise three equally circumferentially spaced spring-biased pushrods.

Aspect 9: The drive assembly of any one of aspects 5-8, further comprising a plurality of housings, wherein each pushrod of the plurality of pushrods is slidably received within a respective housing of the plurality of housings, wherein one of each pushrod and an associated housing is coupled to the driven rotatable element, and wherein the other of each pushrod and the associated housing is coupled to the plurality of drive arms.

Aspect 10: A wheelchair comprising: a frame; a pair of drive wheels that are rotatably coupled to the frame about a drive wheel axis; a drive assembly that is coupled to each drive wheel, wherein the drive assembly comprises: a plurality of drive arms that are rotatably coupled to the frame about a first axis; a push rim that is coupled to the plurality of drive arms; a first sprocket that is coupled to the plurality of drive arms via a coupling subassembly, wherein the coupling subassembly couples the plurality of drive arms to the first sprocket so that the first axis is movable with respect to the second axis along both (i) a first dimension that is perpendicular to the first and second axes and (ii) a second dimension that is perpendicular to the first dimension and the first and second axes, wherein the coupling subassembly is configured to bias the first sprocket toward a position in which the first axis is collinear with the second axis, a second sprocket that is fixedly coupled to a respective drive wheel of the pair of drive wheels; a spacing arm that is coupled to each of the first sprocket and the second sprocket to maintain the first and second sprockets at a select spacing; and a belt or chain extending between and engaging each of the first sprocket and the second sprocket.

Aspect 11: The wheelchair of aspect 10, wherein the coupling subassembly comprises a plurality of spring-biased pushrods that are coupled between the drive arms and the first sprocket.

Aspect 12: The wheelchair of aspect 11, wherein the spring-biased pushrods comprise coiled springs.

Aspect 13: The wheelchair of aspect 11, wherein the spring-biased pushrods comprise air springs.

Aspect 14: The wheelchair of any one of aspects 11-13, wherein the plurality of spring-biased pushrods comprise three equally circumferentially spaced spring-biased pushrods.

Aspect 15: The wheelchair of any one of aspects 11-14, further comprising a plurality of housings, wherein each pushrod of the plurality of pushrods is slidably received within a respective housing of the plurality of housings, wherein one of each pushrod and an associated housing is coupled to the first sprocket, and wherein the other of each pushrod and the associated housing is coupled to the plurality of drive arms.

Aspect 16: The wheelchair of any one of aspects 11-15, wherein the coupling subassembly 120 is configured to selectively lock to inhibit movement of the first sprocket relative to the plurality of drive arms.

Aspect 17: The wheelchair of any one of aspects 11-16, wherein the coupling subassembly 120 comprises at least one damper that is configured to vary at least one characteristic, wherein the at least one characteristic comprises a least one of a damping force, a linear travel, or a rebound rate.

Aspect 18: The wheelchair of aspect 17, further comprising a controller that is operatively coupled to the at least one damper, wherein the controller is configured to change the at least one characteristic based on an input.

Aspect 19: The wheelchair of aspect 18, wherein the input is a user input.

Aspect 20: The wheelchair of aspect 18, further comprising at least one sensor in communication with the controller, wherein the input is configured to provide the input to the controller.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A drive assembly comprising:
a plurality of drive arms that are configured to receive a tangential drive force and convert the tangential drive force to a torque about a first axis;
a driven rotatable element that is rotatable about a second axis that is parallel to the first axis;
a coupling subassembly that couples the plurality of drive arms to the driven rotatable element so that the first axis is movable with respect to the second axis along both (i) a first dimension that is perpendicular to the first and second axes and (ii) a second dimension that is perpendicular to the first dimension and the first and second axes,
wherein the coupling subassembly is configured to bias the driven rotatable element toward a position in which the first axis is collinear with the second axis.

2. The drive assembly of claim 1, further comprising a push rim that is coupled the plurality of drive arms.

3. The drive assembly of claim 1, wherein each drive arm comprises a proximal end intersected by the first axis and a distal end opposing the proximal end, the torque conversion assembly further comprising a pedal coupled to the distal end of each drive arm of the plurality of drive arms.

4. The drive assembly of claim 1, wherein the driven rotatable element is a first sprocket, the torque conversion assembly further comprising:
a second sprocket;
a spacing arm that is coupled to each of the first sprocket and the second sprocket to maintain the first and second sprockets at a select spacing; and
a belt or chain extending between and engaging each of the first sprocket and the second sprocket.

5. The drive assembly of claim 1, wherein the coupling subassembly comprises a plurality of spring-biased pushrods that are coupled between the plurality of drive arms and the driven rotatable element.

6. The drive assembly of claim 5, wherein the spring-biased pushrods comprise coiled springs.

7. The drive assembly of claim 5, wherein the spring-biased pushrods comprise air springs.

8. The drive assembly of claim 5, wherein the plurality of spring-biased pushrods comprise three equally circumferentially spaced spring-biased pushrods.

9. The drive assembly of claim 5, further comprising a plurality of housings, wherein each pushrod of the plurality of pushrods is slidably received within a respective housing of the plurality of housings, wherein one of each pushrod and an associated housing is coupled to the driven rotatable element, and wherein the other of each pushrod and the associated housing is coupled to the plurality of drive arms.

10. A wheelchair comprising:
a frame;
a pair of drive wheels that are rotatably coupled to the frame about a drive wheel axis;
a drive assembly that is coupled to each drive wheel, wherein the drive assembly comprises:
a plurality of drive arms that are rotatably coupled to the frame about a first axis;
a push rim that is coupled to the plurality of drive arms;
a first sprocket that is coupled to the plurality of drive arms via a coupling subassembly, wherein the coupling subassembly couples the plurality of drive arms to the first sprocket so that the first axis is movable with respect to the second axis along both (i) a first dimension that is perpendicular to the first and second axes and (ii) a second dimension that is perpendicular to the first dimension and the first and second axes, wherein the coupling subassembly is configured to bias the first sprocket toward a position in which the first axis is collinear with the second axis,
a second sprocket that is fixedly coupled to a respective drive wheel of the pair of drive wheels;
a spacing arm that is coupled to each of the first sprocket and the second sprocket to maintain the first and second sprockets at a select spacing; and
a belt or chain extending between and engaging each of the first sprocket and the second sprocket.

11. The wheelchair of claim 10, wherein the coupling subassembly comprises a plurality of spring-biased pushrods that are coupled between the drive arms and the first sprocket.

12. The wheelchair of claim 11, wherein the spring-biased pushrods comprise coiled springs.

13. The wheelchair of claim 11, wherein the spring-biased pushrods comprise air springs.

14. The wheelchair of claim 11, wherein the plurality of spring-biased pushrods comprise three equally circumferentially spaced spring-biased pushrods.

15. The wheelchair of claim 11, further comprising a plurality of housings, wherein each pushrod of the plurality of pushrods is slidably received within a respective housing of the plurality of housings, wherein one of each pushrod and an associated housing is coupled to the first sprocket, and wherein the other of each pushrod and the associated housing is coupled to the plurality of drive arms.

16. The wheelchair of claim 11, wherein the coupling subassembly 120 is configured to selectively lock to inhibit movement of the first sprocket relative to the plurality of drive arms.

17. The wheelchair of claim 11, wherein the coupling subassembly 120 comprises at least one damper that is configured to vary at least one characteristic, wherein the at least one characteristic comprises a least one of a damping force, a linear travel, or a rebound rate.

18. The wheelchair of claim 17, further comprising a controller that is operatively coupled to the at least one damper, wherein the controller is configured to change the at least one characteristic based on an input.

19. The wheelchair of claim 18, wherein the input is a user input.

20. The wheelchair of claim 18, further comprising at least one sensor in communication with the controller, wherein the input is configured to provide the input to the controller.
